(19) United States
(12) Patent Application Publication
(10) Pub. No.: US 2006/0091063 A1
(43) Pub. Date: May 4, 2006

(54) Anti-contamination inlet screen for automatic faucets

(76) Inventors: Graham H. Paterson, Wilmington, DE (US); Emil Vulcu, Elkins Park, PA (US)

Correspondence Address: CONNOLLY BOVE LODGE & HUTZ, LLP, P O BOX 2207, WILMINGTON, DE, 19899, US

(21) Appl. No.: 11/266,064

(22) Filed: Nov. 3, 2005

Related U.S. Application Data
(60) Provisional application No. 60/624,734, filed on Nov. 3, 2004.

(51) Int. Cl. B01D 35/28

(52) U.S. Cl. 210/449; 210/499; 210/506

(57) ABSTRACT

Contamination of an automatic faucet with bacteria, e-coli and other harmful materials is avoided by coating inlet screens of such faucets with silver. Contact of the silver coating with water borne contaminants within the faucet removes most harmful contaminants in the water. A screen structure particularly suited for insertion in the water inlet of automatic faucets is disclosed.

### BACKGROUND OF INVENTION

1. Field of Invention

This invention provides protection against latent contamination of automatic faucets with water borne contaminants, like bacteria, e-coli. This protection is provided by coating water inlet screens or other particulate removal means with silver. Particulate removal means are generally placed in automatic faucet water inlets to remove particulate matter that would otherwise interfere with the operation of such faucets by clogging small water passages used therein. These particulate removal means, however, are a breeding ground for contaminants that are trapped on such means and the particulate matter trapped thereon. Applicants have found that coating such screens with silver has yielded unexpected benefits by reducing the potential for contamination of the water emanating from such faucets.

2. Prior Art

While silver has been used in some applications to reduce water borne bacteria contamination, no one has used silver on screens or particulate removal means of automatic faucets to reduce such contamination.

U.S. Pat. No. 6,082,407 assigned to Speakman Company describes one example of a faucet that would benefit from this invention. This faucet contains a screen in the inlet of the solenoid (see Col. 3, lines 24-27 and FIG. 1(a) of U.S. Pat. No. 6,082,407). But that screen is subject to biological contamination from the water supply or from other sources. For example, in a situation where flood waters reach inlets to water treatment plants, biological contamination in the flood waters can be carried by the water supply and collect on the inlet screen of a faucet. Such contaminants are often difficult to dislodge from the inlet screen, even with backflushing or use of astringents such as chlorine. Applicants have found that these problems may be overcome with use of a silver coating on the inlet screen.

Examples of prior uses of silver in water borne applications are described below.

U.S. Pat. No. 6,306,350 issued to ITT Manufacturing Enterprises, Inc. describes a water quality sampling apparatus for extracting biological or chemical analytes from contaminated waterways (col. 1, lines 6-9). The water sample passes through a series of successively finer filter membranes. Among those filters is one of “silver wool . . . for the control of bacterial growth” (col. 5, lines 54-60).

A water cooler is described in U.S. Pat. No. 6,101,835. The cooler includes an in-line E-coli purification module 88 and particulate filter module 89 (col. 7, lines 25-29 and FIG. 3). The primary purification in module 88 is accomplished using an “electron curtain [which] will kill E-coli bacteria and contaminated water as the water passes through the electron curtain” (col. 7, lines 54-59 and FIG. 9). This patent also discloses use of a “silver screen structure” to assist in destruction of E-coli bacteria (Col. 8, lines 5-15).

A drinking cup lid with various filter media, including silver, is disclosed in U.S. Pat. No. 4,999,109. One of the filter media is antibacterial and comprises “an asbestos screen coated with additional bactericidal medium, preferably silver nitrate . . . ” (Col. 4, lines 34-38 and FIG. 3).

U.S. Pat. No. 4,287,057 issued Sep. 1, 1981 discloses a portable sink top water conditioner for filtering tap water. Mechanical screens 38 help to contain activated charcoal within the filter. “[O]ne or more of the screens may be silver plated” to reduce the bacteria count in the water (Col. 2, lines 51-65).

### SUMMARY OF INVENTION

An object of this invention is to prevent contamination of automatic faucets containing large particle water inlet screens or other particulate removal means. Such means have a tendency to trap bacteria, e-coli and other contaminants that are difficult to physically remove or neutralize. The contamination is particularly prevalent with automatic faucets in which water flow occurs only occasionally and for short periods of time. For example, in a hospital setting automatic faucets are typically only used to wash hands, for example, at a surgical scrub sink. In such an application water may only run through the faucet a few minutes a day and may sit quiescent within the faucet for long periods, e.g. overnight or over weekends.

Almost all automatic faucets must have inlet screens or filters to avoid clogging of small internal passages used in such faucets. Typically these faucets use a pressure balanced diaphragm with minute bleed holes to control flow through the faucet, for example, as described in U.S. Pat. No. 4,948,090 incorporated herein by reference. As illustrated in this and like patents, free flow of water through these bleed holes is essential to distribute pressure across an operating diaphragm. Thus, particulate matter in a water supply can seriously impair operation of such valves by impeding movement of parts or clogging passages. Accordingly, screens or filters are essentially mandatory in such valves. Such screens or filters, however, are a natural habitat for growth of bacteria and other contaminants. This problem is exacerbated in those situations where the water supply has been compromised by flood, problems at a water utility's filtration plant or inflow of farm runoff into artesian wells.

The current invention solves these and other contamination problems by providing an antibacterial coating on the automatic valve inlet screen, filter, or other particulate removal means. The efficacy of this coating as a means of limiting contamination of water passing through the inlet screen has been established by careful laboratory testing.

The inlet screen or filter preferably comprises a stainless steel foraminous member coated with a pure silver coating. In a typical application the inlet screen or filter is formed as a cylindrical sleeve having a diameter of about one half inch (1.2 cm.) and height of about one inch (2.5 cm.). The screen or filter is provided with structural integrity by embedding the open edges of the circular sleeve in a plastic or rubber housing to form sealing washers at each open end thereof. Further structural integrity can be provided for the screen or filter housing by molding reinforcing ribs along the length of the sleeve.

### BRIEF DESCRIPTION OF THE DRAWINGS

FIG. 1 is a side elevational view of the automatic faucet assembly of this invention;

FIG. 2 is a fragmental exploded cross-sectional view in elevation showing the faucet water inlet; the filter screen housing, the silver coated filter screen and the faucet water inlet closure;

FIG. 3 is a fragmental cross-sectioned view of the assembled components of FIG. 2;

FIG. 4 is a top plan view of the filter screen housing;

FIG. 5 is a bottom plan view of the filer screen housing; and

FIG. 6 is a front elevational view of the filter screen.

### DETAILED DESCRIPTION OF INVENTION

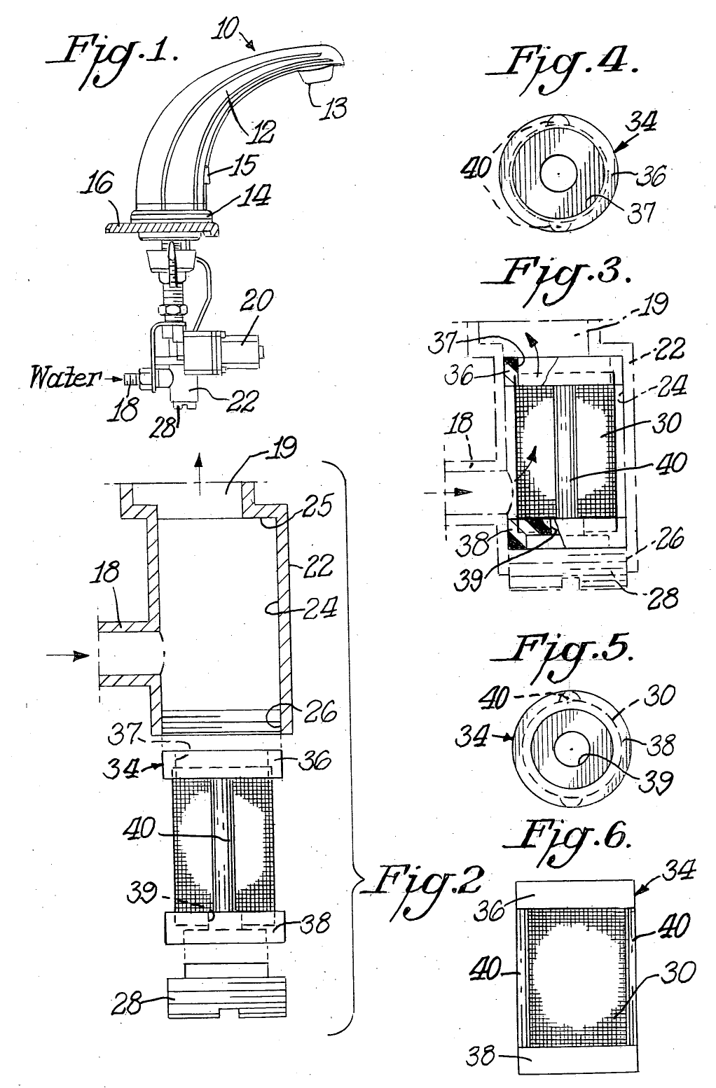

FIG. 1 illustrates a typical automatic faucet 10 arrangement in which the inlet screen of this invention can be utilized. The structure and operation of automatic faucet 10 are set forth in the specification and drawings of commonly assigned U.S. Pat. No. 6,082,407 which is incorporated herein by reference. In the typical automatic faucet assembly, a faucet spout 12 is angled upward and over a sink (not shown) to discharge water from faucet outlet 13. The faucet spout 12 is typically mounted on a deck plate 14 to facilitate mounting of faucet 10 to a solid surface or deck 16 surrounding the sink.

Potable water is supplied to faucet 10 at water inlet 18 which typically includes a threaded or sweated connection for attachment of water supply tubing or piping (not shown). Flow through faucet 10 from water inlet 18 to faucet outlet 13 is controlled by solenoid operated valve 20 which is typically activated by an optical or infrared sensor 15 for sensing the presence of a user of the faucet 10.

A water inlet housing 22 is located downstream of water inlet 18 and upstream of solenoid operated valve 20. This housing 22 is depicted on FIGS. 2 and 3 and typically comprises a central bore 24 therein which is in fluid communication with water entering the faucet 10 through inlet 18. The water entering through inlet 18 passes through bore 24 of the housing 22 and exits through water outlet port 19. Water passing through outlet port 19 then enters solenoid 20 where its further passage through faucet 10 to water outlet 13 is controlled by solenoid valve 20. One end of the bore 24 of water inlet housing 22 typically contains a threaded end closure 28. Mating threads 26 in the housing 22 allow ready removal and replacement of closure 28.

The removal and replacement of closure 28 is necessary to accommodate the placement of an inlet screen or filter 30 within bore 24 of water inlet housing 22 to collect particulate matter in the water entering inlet 18. This particulate removal means 30 is typically used in most, if not all, automatic faucets to filter out particles or other debris that might interfere with the operation of solenoid valve 20, as explained above. The particles and debris that collect on particulate removal means 30 must be periodically removed to prevent clogging thereof that would impede flow of water through faucet 10. Accordingly, closure 28 may be periodically opened to allow removal and cleansing of particulate removal means 30.

This means 30 is coated with silver to reduce water borne contamination. Particulate removal means 30 can be fabricated from any foraminous material that will support this silver coating, but is preferably made of stainless steel.

To facilitate insertion, retention and removal of particulate removal means 30 in water inlet housing 22, it is preferably placed in a housing 34 as illustrated in FIGS. 2-6. As shown in this preferred embodiment, particulate removal means 30 within housing 34 is a stainless steel mesh coated with silver formed as a circular sleeve having a diameter of about one-half inch (1.2 cm) and length of about one (1) inch (2.5 cm). Each end of the housing 34 includes molded washers 36 and 38 which are dimensioned to provide a sealing engagement with the top 25 of inlet housing bore 24 and the inlet housing closure 28, respectively. A central opening 37 (See FIG. 2-4) in molded washer 36 facilitates passage of water out the housing 34 into water outlet 19 of the water inlet housing 22. A smaller opening 39 in washer 38 facilitates seating of the housing 34 on housing closure 28. The structure of housing 34 is preferably strengthened with vertical ribs 40 extending between washers 36 and 38.

### EXAMPLE

The efficacy of using silver coated particulate removal means in automatic faucets to reduce water contamination is confirmed by the following test results commissioned by the assignee of this application.

Eight identical automatic faucets were exposed to contaminated water. Two of the faucets had “standard” uncoated inlet screens (100×100 mesh). Two had “coarse” silver plated internal screens made of coarser than standard screen which was silver plated; and four had “fine” silver plated internal screens (same screen mesh as the standard screens). After a three week exposure to contaminated water having a relatively high bacteria count (HPC>10,000 CFU's/ml) and a relatively low particulate level (TSS<10 mg/l), non-chlorinated well water having a relatively low bacteria count (HPC of 1) was run through the faucet for 60 minutes. Samples were collected at 15, 30, 45 and 60 minutes. Results are summarized below:

| | | | | | | | | | | Draw Off | |
|---|---|---|---|---|---|---|---|---|---|---|---|
| | Standard Inlet Screen | | | Coarse Silver Screen | | | Fine Silver Screen | | | Valve | |
| Time | | Mean HPC | Std. | | Mean HPC | Std. | | Mean HPC | Std. | | HPC |
| (min.) | n | (CFU/ml) | Dev. | N | (CFU/ml) | Dev. | n | (CFU/ml) | Dev. | n | CFU/ml |
| 15 | 2 | 435 | 35.6 | 2 | 79.5 | 43.1 | 4 | 144 | 125.2 | 1 | 28 |
| 30 | 2 | 291 | 210 | 2 | 113 | 77.8 | 4 | 126 | 28.5 | 1 | 31 |
| 45 | 2 | 55.0 | 1.41 | 2 | 39.5 | 6.36 | 4 | 40.0 | 9.93 | 1 | 26 |
| 60 | 2 | 71.5 | 9.19 | 2 | 48.0 | 1.41 | 4 | 42.5 | 12.4 | 1 | 28 |

The above results confirms that water contaminants are substantially reduced by coating the automatic faucet inlet screen with silver. For example, after fresh water (HPC of 1 or less) is run through the inlet screens for 15 minutes after contaminated water (HPC of >10,000) is run through the inlet screens, there is a substantial reduction in the HPC count (435 reduced to between 79.5 and 144) in the faucet with silver coated screens versus uncoated screens. As more clean water passes through the faucet, e.g. after one hour, the reduction in contamination, (71 reduced to 48) is lesser because the clean water has flushed out much of the contamination. But the 15 minute test in this table best illustrates the conditions that might be experienced in actual use where contamination grows during non-use of a faucet followed by a short period of fresh water passing through the faucet.

We claim:

1. A particulate removal device for placement in the water supply path to an automatic faucet comprising,
a foraminous member interposed within the water supply path to limit passage of particulate matter therethrough,
the foraminous member being coated with silver to inhibit contamination of the foraminous member, particulate matter therein and water passing therethrough.

2. The particulate removal device of claim 1 wherein the foraminous member is a screen.

3. The particulate removal device of claim 2 wherein the screen wire caliber is course.

4. The particulate removal device of claim 2 wherein the screen wire caliber is fine.

5. The particulate removal device of claim 2 wherein the screen is formed into a housing which is removably placed in the inlet of the automatic faucet.

6. The particulate removal device of claim 5 wherein the housing comprises a circular silver coated screen embedded at the ends in moldable washers.

7. The particulate removal device of claim 6 wherein at least one vertical rib extends between the washers.

8. The particulate removal device of claim 1 wherein the foraminous member is a filter.
